(19) United States
(12) Patent Application Publication
(10) Pub. No.: US 2024/0395062 A1
(43) Pub. Date: Nov. 28, 2024

(54) CHARACTER RECOGNITION DEVICE, CHARACTER RECOGNITION METHOD, AND NON-TRANSITORY COMPUTER-READABLE STORAGE MEDIUM STORING PROGRAM

(71) Applicant: Panasonic Intellectual Property Management Co., Ltd., Osaka (JP)

(72) Inventors: Riku MATSUMOTO, Hyogo (JP); Masamitsu Murase, Kyoto (JP)

(21) Appl. No.: 18/793,071

(22) Filed: Aug. 2, 2024

Related U.S. Application Data
(63) Continuation of application No. PCT/JP2022/040880, filed on Nov. 1, 2022.

(30) Foreign Application Priority Data
Apr. 13, 2022 (JP) 2022-066399

(51) Int. Cl. G06V 30/10; G06T 3/40; G06T 5/50; G06V 10/25

(52) U.S. Cl. CPC G06V 30/10; G06T 3/40; G06T 5/50; G06V 10/25; G06T 2207/20221

(57) ABSTRACT

A CPU in a character recognition device detects at least one candidate character area having a likelihood higher than zero in the input image, the likelihood being a likelihood of including a character. The CPU determines that a candidate character area having a likelihood higher than a threshold as a character area. The CPU then superimposes the character area over the input image, and displays the resultant image. The CPU acquires a user input designating a first point on the input image. The CPU raises the likelihood of the candidate character area that is included in a first correction area including the first point. The CPU determines a candidate character area having a likelihood higher than a threshold as a character area again. The CPU then superimposes the character area over the input image and displays the resultant image again. The CPU recognizes the characters included in the character areas.

### TECHNICAL FIELD

The present disclosure relates to a character recognition device, a character recognition method, and a non-transitory computer-readable storage medium storing a program.

### BACKGROUND ART

When a computer attempts to recognize characters included in an image automatically, the computer may fail to recognize some of the characters in the image, or mistakenly recognize some objects that are not characters as characters. In such a case, a computer or a user needs to perform additional operations to reattempt to recognize the characters failed to be recognized, or to delete the mistakenly recognized characters.

For example, PTL 1 discloses a character recognition device capable of acquiring a result of character recognition as a text, with hidden characters interpolated, when there are some characters that are actually included in a scenery captured as a scenery image but not visible because the characters are hidden (hidden characters).

### CITATION LIST

### Patent Literature

PTL 1: Japanese Patent No. 6342298

### SUMMARY OF THE INVENTION

If the user is to perform manual operations to reattempt to recognize the characters having failed to be recognized, the user needs to bear the burden of designating the areas including the characters. Therefore, there is a demand for reducing the burden in reattempts in recognizing characters failed to be recognized.

An object of the present disclosure is to provide a character recognition device, a character recognition method, and a non-transitory computer-readable storage medium storing a program allowing a reattempt for recognizing a character having once failed to be recognized, with a less burden.

According to one aspect of the present disclosure, a character recognition device configured to process an input image and to recognize a character included in the input image, the character recognition device includes:
an arithmetic circuit; and
a memory that stores an instruction executable by the arithmetic circuit,
wherein the arithmetic circuit is configured to, upon executing the instruction:
   detect at least one candidate character area having a likelihood higher than zero in the input image, the likelihood being a likelihood of including a character;
   determine a candidate character area with a likelihood higher than a predetermined threshold, as a character area, among the at least one candidate character area;
   superimpose the character area over the input image, and display a resultant image on a display;
   acquire a first user input designating a first point in the input image, via an input device;
   raise a likelihood of a candidate character area that is included in a first correction area including the first point, among the at least one candidate character area;
   determine a candidate character area having a likelihood higher than the predetermined threshold as a character area again, among the at least one candidate character area;
   superimpose the character area over the input image and displaying of a resultant image again on the display; and
   recognize a character included in the character area.

With the character recognition device according to one aspect of the present disclosure, it is possible to make a reattempt for recognizing a character having once failed to be recognized, with a less burden.

### BRIEF DESCRIPTION OF THE DRAWINGS

FIG. 1 is a block diagram illustrating a configuration of character recognition device 1 according to a first exemplary embodiment.

FIG. 2 is a flowchart illustrating character recognition processing performed by CPU 11 in FIG. 1.

FIG. 3 is a schematic illustrating an example of input image 20 captured by image capturing device 14 illustrated in FIG. 1.

FIG. 4 is a schematic illustrating an example of an image displayed on display 16 in FIG. 1, the image including a character area failed to be detected.

FIG. 5 is a schematic for describing processing of reattempt for detecting a character area once failed to be detected.

FIG. 6 is a graph illustrating the likelihoods of respective candidate character areas along the line A-A′ in FIG. 5.

FIG. 7 is a graph resultant of applying a correction to the likelihood of candidate character area 34c′ indicated in FIG. 6.

FIG. 8 is a schematic illustrating an example of an image displayed on display 16 in FIG. 1, illustrating an example in which character area 34c once having failed to be detected is detected successfully.

FIG. 9 is a schematic illustrating an example of an image displayed on display 16 in FIG. 1, the image including an area mistakenly detected as a character area.

FIG. 10 is a schematic for describing processing of deleting the area having been mistakenly detected as a character area.

FIG. 11 is a block diagram illustrating a configuration of character recognition system 40 according to a second exemplary embodiment.

### DESCRIPTION OF EMBODIMENTS

Exemplary embodiments will now be described below in detail, referring to the drawings as appropriate. Unnecessarily detailed description is sometimes omitted. For example, detailed descriptions of already well-known matters and the redundant description of substantially identical configurations may be omitted. These omissions are made to avoid unnecessarily redundancy in the description below, and to facilitate understanding of those skilled in the art.

Note that, the inventor(s) of the present disclosure provide the accompanying drawings and the following description for the purpose of assisting those skilled in the art to fully understand the present disclosure, and thus do not intend to limit the subject matter defined in the appended claims in any way.

### First Exemplary Embodiment

A character recognition device according to a first exemplary embodiment is configured as an integrated computer including an image capturing device, an input device, and a display, an example of which is a tablet computer.

### Configuration According to First Exemplary Embodiment

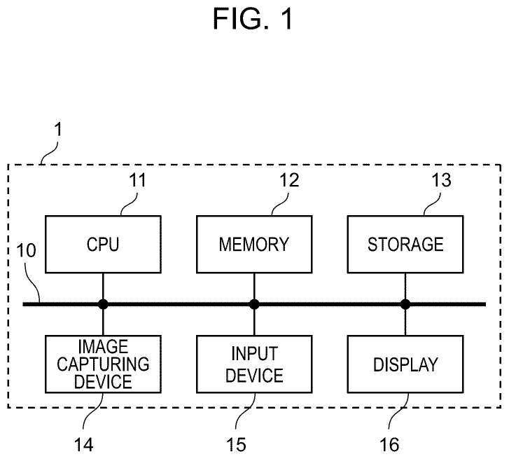

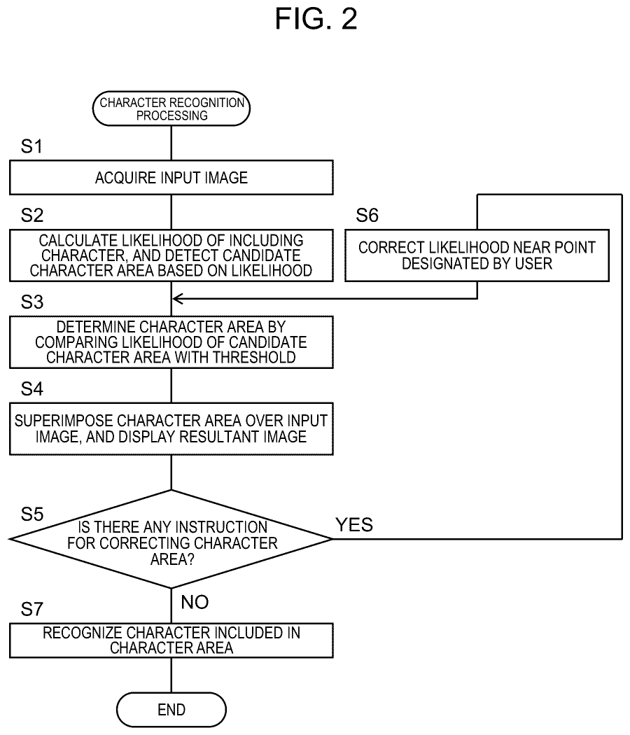

FIG. 1 is a block diagram illustrating a configuration of character recognition device 1 according to a first exemplary embodiment. Character recognition device 1 includes bus 10, central processing unit (CPU) 11, memory 12, storage 13, image capturing device 14, input device 15, and display 16. CPU 11 processes an input image captured by image capturing device 14, and recognizes the characters included in the input image, by controlling the operation of entire character recognition device 1 and executing character recognition processing, which will be described later with reference to FIG. 2. Memory 12 temporarily stores therein a program and data required for the operation of character recognition device 1. Storage 13 is a non-transitory computer-readable storage medium that stores therein a program required for the operation of character recognition device 1. Storage 13 is implemented by, for example, a semiconductor storage device such as a flash memory or a solid state drive (SSD), a magnetic storage device such as a hard disk drive (HDD), or other storage media alone or in combination thereof. Image capturing device 14 generates an input image by capturing an image of an object. One example of image capturing device 14 is an RGB camera. Input device 15 receives a user input for controlling the operations of character recognition device 1. Examples of input device 15 includes a keyboard and a pointing device, display 16 is a display that displays an input image, recognized characters, and the like. CPU 11, memory 12, storage 13, image capturing device 14, input device 15, and display 16 are connected to one another via bus 10.

An example of input device 15 is a touch panel device with integrated display 16, and may be operated using a finger of the user or a stylus.

CPU 11 is an example of an arithmetic circuit. The program stored in memory 12 and storage 13 is one example of an instruction executable by CPU 11.

Described in the exemplary embodiment of the present disclosure is an example in which character strings printed on terminals of a distribution board and/or character strings printed on cables connected to the distribution board are to be recognized.

### Operation According to First Exemplary Embodiment

FIG. 2 is a flowchart illustrating character recognition processing executed by CPU 11 in FIG. 1.

In step S1, CPU 11 acquires an input image captured by image capturing device 14.

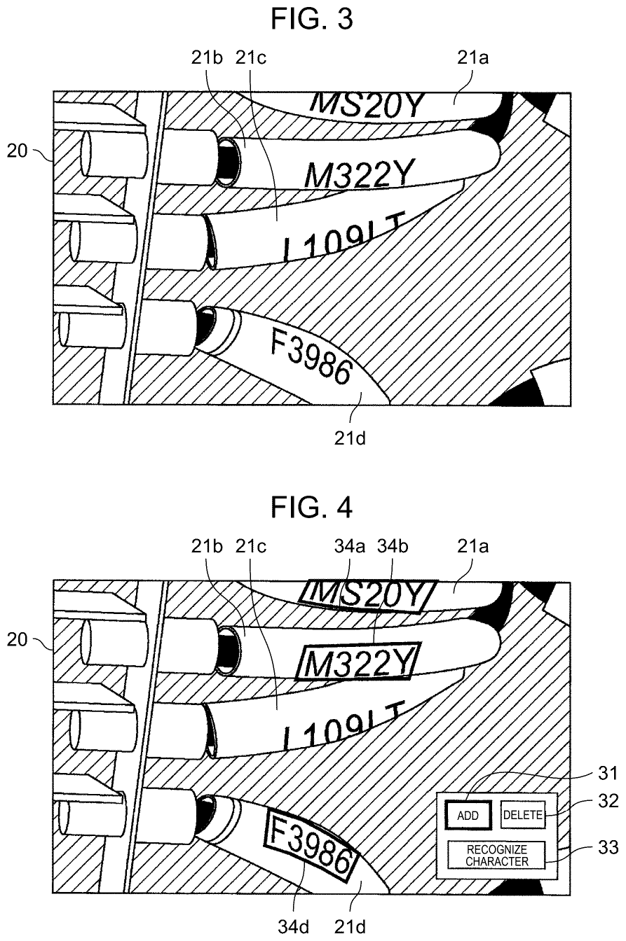

FIG. 3 is a schematic illustrating an example of input image 20 captured by image capturing device 14 illustrated in FIG. 1. Described in the exemplary embodiment according to the present disclosure is an example in which input image 20 includes cables 21a to 21d, and character strings printed on respective cables 21a to 21d are to be recognized.

In step S2, CPU 11 calculates the likelihood of a character being included in each of a plurality of partial images resultant of dividing the input image, and detects at least one candidate character area based on the likelihood. In the description herein, a “candidate character area” means an area having a likelihood of a character being included, higher than zero. The likelihood of a candidate character area may be calculated in any manner that is known in the art of the character recognition.

In step S3, CPU 11 compares the likelihood of each of the candidate character areas with predetermined threshold Th, and determines a candidate character area having a likelihood higher than threshold Th as a character area. In the description herein, a “character area” means a target area from which a character is to be recognized using a predetermined character recognition algorithm.

In step S4, CPU 11 superimposes the character area over the input image, and displays the resultant image on display 16.

FIG. 4 is a schematic illustrating an example of an image displayed on display 16 illustrated in FIG. 1. The image displayed on display 16 includes input image 20 (see FIG. 3), and also includes a frame including ADD button 31, DELETE button 32, RECOGNIZE CHARACTER button 33, and character areas 34a, 34b, and 34d, the frame and the character areas 34a, 34b, and 34d being superimposed over input image 20. ADD button 31 is used for reattempting a detection of a character area failed to be detected, when there is any. DELETE button 32 is used to delete a character area not including any character but mistakenly detected as including a character (that is, an area mistakenly detected as a character area), when there is any. RECOGNIZE CHARACTER button 33 is used in recognizing the character included in the detected character area. Character areas 34a, 34b, and 34d correspond to character strings on cables 21a, 21b, and 21d, respectively. Using input device 15, a user can press ADD button 31, DELETE button 32, and RECOGNIZE CHARACTER button 33, and designate a point in input image 20. In the example illustrated in FIG. 4, the character string on cable 21c has failed to be detected as a character area.

When there is any character area failed to be detected, or when there is any character area detected mistakenly, it is necessary to correct such character areas. The user of character recognition device 1 checks the image displayed on display 16, and give an instruction for correcting the character area to character recognition device 1, as required.

In step S5, CPU 11 determines whether an instruction for correcting a character area has been given, on the basis of the user input. If YES, the process is shifted to step S6. If NO, the process is shifted to step S7. Referring to FIG. 4, if ADD button 31 or DELETE button 32 displayed on display 16 is pressed down, and then a point in input image 20 is designated, CPU 11 determines that an instruction for correcting the character area has been given, and the process is shifted to step S6. If RECOGNIZE CHARACTER button 33 displayed on display 16 is pressed down, the process is shifted to step S7.

In step S6, CPU 11 corrects the likelihood of an area that is near the point designated by the user and that is included in one of candidate character areas (that is, one of the areas with a likelihood higher than zero). If there is any character area failed to be detected, CPU 11 raises the likelihood of the area by adding or multiplying a predetermined value to the original likelihood. If there is any character area mistakenly detected, CPU 11 reduces the likelihood of the area by subtracting or multiplying a predetermined value from or to the original likelihood.

Steps S3 to S6 are repeated until the user determines that all character areas in the input image have been detected correctly.

In step S7, CPU 11 recognizes a character included in the character area using some character recognition algorithm that is known in the technical field of the character recognition. The recognized characters may be displayed on display 16 as text data, or further processed by another application program executed by CPU 11.

Described now with reference to FIGS. 4 to 8 is how a character area failed to be detected is corrected, when there is any.

FIG. 4 is a schematic illustrating an example of an image displayed on display 16 in FIG. 1, the image including a character area failed to be detected, as described above. In the example illustrated in FIG. 4, the character string on cable 21c has failed to be detected as a character area.

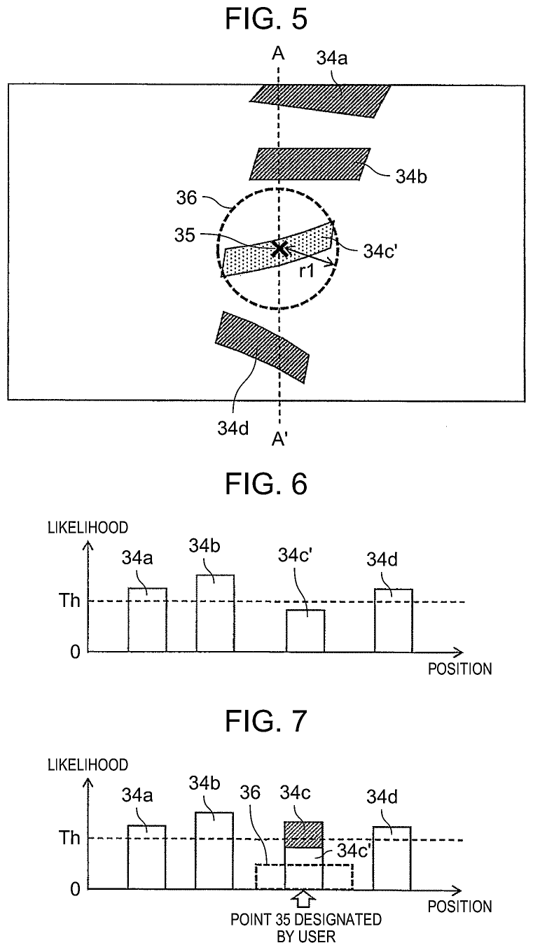

FIG. 5 is a schematic for describing processing of a reattempt for detecting a character area once failed to be detected. FIG. 6 is a graph illustrating the likelihoods of the respective candidate character areas along the line A-A′ in FIG. 5. FIG. 7 is a graph resultant of applying a correction to the likelihood of candidate character area 34c′ indicated in FIG. 6.

Referring to FIG. 6, because candidate character areas 34a, 34b, and 34d corresponding to the character strings on respective cables 21a, 21b, and 21d have likelihoods higher than threshold Th, candidate character areas 34a, 34b, and 34d are determined as character areas 34a, 34b, and 34d, respectively, without any correction. By contrast, candidate character area 34c′ corresponding to the character string on cable 21c has a likelihood lower than threshold Th. Therefore, this area is not handled as a character area. In such a case, character areas 34a, 34b, and 34d are displayed on display 16, but no candidate character area 34c′ is displayed on display 16, as illustrated in FIG. 4.

In order to have candidate character area 34c′ handled as a character area, the user presses ADD button 31 displayed on display 16, and then designates point 35 inside or near candidate character area 34c′, as indicated in FIG. 5. As illustrated in FIG. 7, CPU 11 generates candidate character area 34c having the likelihood corrected, by raising the likelihood of an area that is included in correction area 36 near point 35 (a first correction area including point 35) and that is within candidate character area 34c′. The example illustrated in FIG. 7 represents an example in which a constant value is added to the likelihood of the candidate character area 34c′ that is included in correction area 36. Because the likelihood of the corrected candidate character area 34c is now higher than threshold Th, CPU 11 determines candidate character area 34c as character area 34c. CPU 11 then superimposes character area 34c over input image 20, and displays the resultant image on display 16. Note that, in another example, CPU 11 generates candidate character area 34c having the likelihood corrected by raising the likelihood of the candidate character area 34c′ that has a likelihood equal to or lower than threshold Th and that is nearest to point 35 in correction area 36.

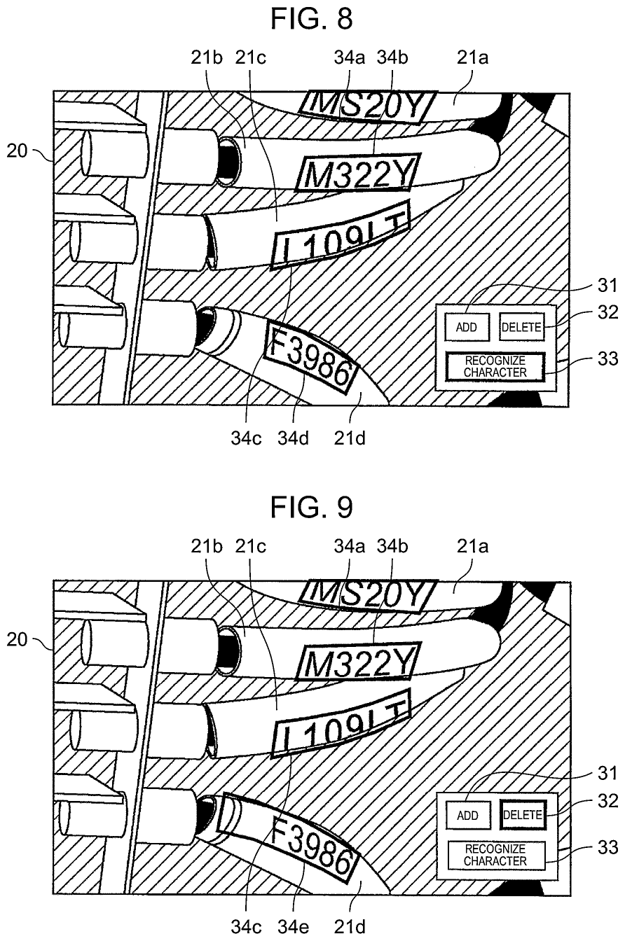

FIG. 8 is a schematic illustrating an example of an image displayed on display 16 in FIG. 1, illustrating an example in which character area 34c once having failed to be detected is detected successfully. Because the likelihood of the candidate character area is corrected, character areas 34a to 34d corresponding to all of the character strings included in input image 20 are now recognized successfully, as illustrated in FIG. 8. When RECOGNIZE CHARACTER button 33 displayed on display 16 is then pressed, CPU 11 is caused to recognize the characters included in character areas 34a to 34d.

Correction area 36 may be, for example, a circular area having radius r1 with respect to the center at point 35, which has been designated by the user. The size of correction area 36 (e.g., the length of the radius r1) may be set longer when a longer time is accrued in designating point 35 using the pointing device of input device 15. In a configuration in which the pointing device of input device 15 is capable of detecting pressure, the size of correction area 36 (e.g., the length of radius r1) may be set greater in response to a designation of point 35 at a greater strength, the designation being made with the pointing device of input device 15.

Described with reference to FIG. 7 is an example in which a constant value is added to the likelihood of the candidate character area 34c′ included in correction area 36. However, the likelihood of a candidate character area may also be corrected by multiplying a coefficient greater than one to the likelihood of the candidate character area included in the correction area.

In the example described with reference to FIG. 7, a constant amount of correction is applied across entire correction area 36; however, it is also possible to set a smaller amount of correction at distance r that is further away from point 35. The amount of correction at distance r from point 35 may also be set as a·exp (−r²/b) (where a and b are positive constants), for example.

When correction area 36 cannot cover the entire candidate character area to be corrected, the correction of the likelihood may be repeated until the likelihood is corrected for the entire candidate character area. Furthermore, when the likelihood does not reach threshold Th even by correcting the likelihood of the candidate character area once, the correction of the likelihood may be repeated until the likelihood becomes higher than threshold Th.

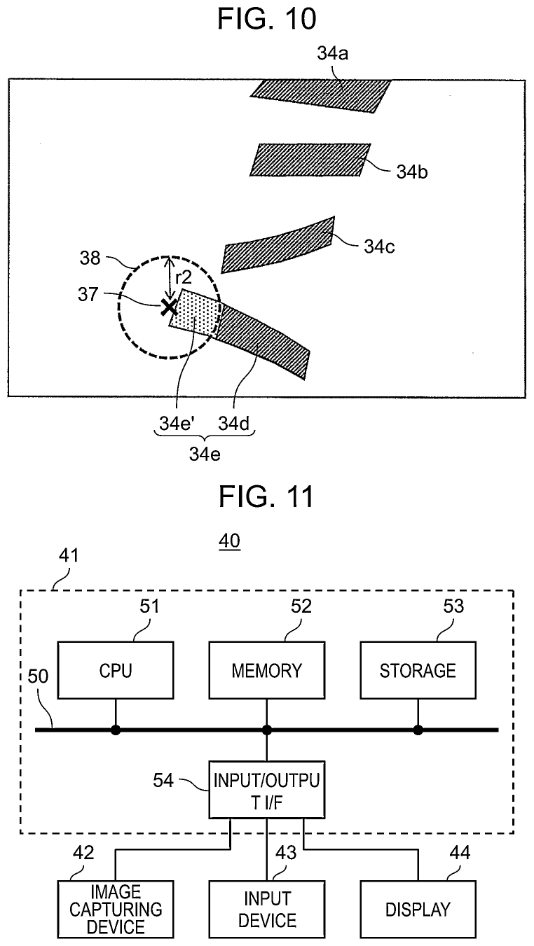

Described now with reference to FIGS. 9 to 10 is how a mistakenly detected character area is corrected, when there is such a character area.

FIG. 9 is a schematic illustrating an example of an image displayed on display 16 in FIG. 1, the image including an area mistakenly detected as a character area. In FIG. 9, character area 34e includes not only the character string on cable 21d but also the pattern on the surface of cable 21d. In other words, in character area 34c, the pattern on cable 21d is mistakenly detected as a character candidate.

FIG. 10 is a schematic for describing processing of deleting the area having been mistakenly detected as a character area. Candidate character area 34e includes area 34d corresponding to the character string on cable 21d, and area 34e′ corresponding to the pattern on cable 21d. The initial likelihood of this entire candidate character area 34c is higher than threshold Th, and therefore is determined as character area 34c. In such a case, character area 34c is displayed on display 16, as illustrated in FIG. 9.

In order to delete area 34e′ from the character area, the user presses DELETE button 32 displayed on display 16, and then designates point 37 inside or near area 34e′, as illustrated in FIG. 10. CPU 11 then lowers the likelihood of area 34e′ that is included in correction area 38 near point 37 (a second correction area including point 37) and that is also within candidate character area 34c. Because the corrected likelihood of area 34e′ is now lower than threshold Th, CPU 11 determines only area 34d included in candidate character area 34c as character area 34d. CPU 11 then superimposes character area 34d over input image 20, and displays the resultant image on display 16. In other words, CPU 11 neither superimposes area 34e′ of candidate character area 34e over input image 20, nor displays area 34e′ on display 16. By correcting the likelihood of the candidate character area, it is possible to detect character areas 34a to 34d corresponding to all the character strings included in input image 20, without any mistakenly detected character area included, as illustrated in FIG. 8.

Correction area 38 may be, for example, a circular area having radius r2 with respect to the center at point 37, which has been designated by the user. The size of correction area 38 (e.g., the length of the radius r2) may be set longer when a longer time is accrued in designating point 37 using the pointing device of input device 15. In a configuration in which the pointing device of input device 15 is capable of detecting pressure, the size of correction area 38 (e.g., the length of radius r2) may be set greater in response to a designation of point 37 at a greater strength, the designation being made with the pointing device of input device 15.

To lower the likelihood of any candidate character area or the likelihood of a partial area thereof, a constant value may be subtracted from the likelihood of the area, or a coefficient less than one may be multiplied to the likelihood of the area.

The amount of correction may remain constant across entire correction area 38. Alternatively, it is also possible to set a smaller amount of correction at distance r that is further away from point 37. The amount of correction at distance r from point 37 may also be set as a·exp (−r²/b) (where a and b are positive constants), for example.

When correction area 38 cannot cover the entire candidate character area to be corrected, the correction of the likelihood may be repeated until the likelihood is corrected for the entire candidate character area. Furthermore, when the likelihood does not fall below threshold Th even by correcting the likelihood of the candidate character area once, the correction of the likelihood may be repeated until the likelihood becomes lower than threshold Th.

As described above, with character recognition device 1 according to the exemplary embodiment, by correcting the likelihood of the candidate character area, it becomes possible to make a reattempt for detecting a character area once failed to be detected; therefore, it is possible to suppress character recognition misses, or to recognize a character having failed to be recognized once. Furthermore, with character recognition device 1 according to the exemplary embodiment, by correcting the likelihood of the candidate character area, it becomes possible to delete a mistakenly detected character area; therefore, it is possible to suppress character recognition mistakes, or to delete the characters having been mistakenly recognized.

With character recognition device 1 according to the exemplary embodiment, a user can make a correction of a character area (that is, detection a character area once failed to be detected, or delete a mistakenly detected character area) merely by designating (tapping or clicking on) one point on the input image. When a character area is to be corrected using conventional character recognition, the user needs to surround a target character area with a rectangular bounding box. The bounding box is generated in response to a user designating the positions corresponding to the upper right and the lower left (or upper left and lower right) vertices, or in response to the user designating the positions corresponding to four vertices, for example. However, the former has a disadvantage that the directions of the sides of the bounding box are limited to those matching the directions of the sides of the image, and the latter requires cumbersome operations, although the bounding box can be set to any shape in any direction. In addition, with both of these approaches for generating a bounding box, errors are introduced in the position and the dimension of the bounding box, because of the user intervention in making the operation. By contrast, with character recognition device 1 according to the exemplary embodiment, the user only needs to designate one point on the input image, and character recognition device 1 automatically corrects the likelihood of an area that is included in a correction area near the designated point and that is also within a candidate character area. With character recognition device 1 according to the exemplary embodiment, because a smaller number of user operations is required, compared with that conventionally required, it is possible to correct the character area stably with less errors. With character recognition device 1 according to the exemplary embodiment, the character area can be corrected using the same processing, regardless of the direction of the character string with respect to the sides of the input image (parallel, perpendicular, or oblique).

With character recognition device 1 according to the exemplary embodiment, because the user can correct the character area easily, threshold Th may be set somewhat high so as to reduce the chances at which some area without any character is detected as a character area by mistake, under an assumption that the user will probably reattempt to detect the character area failed to be detected. As a result, it becomes possible to suppress character recognition mistakes, and to avoid useless computations resultant of recognition mistakes.

Character recognition device 1 may recognize a character string printed on a terminal of a distribution board, and a character string printed on a cable connected to the distribution board. In such a case, character recognition device 1 may run a matching of the character string on the terminal with the character string on the cable. In this manner, one operator can easily determine whether a cable is connected to the correct terminal, merely by capturing an image of the distribution board using character recognition device 1.

### Effects Achieved by First Exemplary Embodiment

Character recognition device 1 according to one aspect of the present disclosure recognizes a character included in an input image by processing the input image. Character recognition device 1 includes CPU 11 and a memory that stores therein instructions that are executable by CPU 11. Upon executing an instruction, CPU 11 detects at least one candidate character area having a likelihood higher than zero from the input image, the likelihood being a likelihood of including a character. Upon executing an instruction, CPU 11 determines a candidate character area having a likelihood higher than a predetermined threshold as a character area, among the candidate character areas. Upon executing an instruction, CPU 11 superimposes the character area over the input image, and displays the resultant image on display 16. Upon executing an instruction, CPU 11 acquires a first user input designating a first point on the input image, via input device 15. Upon executing an instruction, CPU 11 raises the likelihood of the candidate character area that is included in a first correction area that is near the first point, among the candidate character areas. Upon executing an instruction, CPU 11 determines a candidate character area having a likelihood higher than the predetermined threshold as a character area again, among the candidate character areas. Upon executing an instruction, CPU 11 superimposes the character area over the input image and displays the resultant image again on display 16. Upon executing an instruction, CPU 11 recognizes the characters included in the character areas.

As a result, it becomes possible to make a reattempt for recognizing a character once failed to be recognized, with a less burden, compared with that required in the conventional counterpart.

In character recognition device 1 according to one aspect of the present disclosure, input device 15 may include a pointing device. Upon executing an instruction, CPU 11 may increase the size of the first correction area, in accordance with the time length accrued in designating the first point or the strength at which the first point is designated, using the pointing device.

With this, it becomes possible to easily make a reattempt for detecting any character area once failed to be detected, in any size.

With character recognition device 1 according to one aspect of the present disclosure, upon executing an instruction, CPU 11 may acquire a second user input designating a second point on the input image, via input device 15. In such a case, upon executing an instruction, CPU 11 lowers the likelihood of the candidate character area included in a second correction area that is near the second point, among the candidate character areas.

As a result, it becomes possible to delete mistakenly recognized characters with a less burden, compared with that required in the conventional counterpart.

In character recognition device 1 according to one aspect of the present disclosure, input device 15 may include a pointing device. Upon executing an instruction, CPU 11 may increase the size of the second correction area in accordance with the time length accrued in designating the second point, or strength at which the second point is designated, using the pointing device.

As a result, it becomes possible to easily delete mistakenly detected character areas in any size.

Character recognition device 1 according to one aspect of the present disclosure may further include image capturing device 14 that generates an input image. Character recognition device 1 according to one aspect of the present disclosure may further include input device 15 and display 16. In character recognition device 1 according to one aspect of the present disclosure, input device 15 may be a touch panel device with integrated display 16.

On the basis of the above, character recognition device 1 may be configured as a tablet computer, for example.

With a character recognition method according to one aspect of the present disclosure, a character included in the input image is recognized by processing an input image. The method includes a step of detecting at least one candidate character area having a likelihood higher than zero in the input image, the likelihood being a likelihood of including a character. The method includes a step of determining a candidate character area having a likelihood higher than a predetermined threshold as a character area, among the candidate character areas. The method includes a step of superimposing the character area over the input image, and displaying a resultant image on display 16. The method includes a step of acquiring a first user input designating a first point on the input image, via input device 15. The method includes a step of raising the likelihood of a candidate character area that is included in a first correction area near a first point, among the candidate character areas. The method includes a step of determining a candidate character area having a likelihood higher than the predetermined threshold as a character area again, among the candidate character areas. The method includes a step of superimposing the character area over the input image and displaying the resultant input image again on display 16. The method includes a step of recognizing a character included in the character area.

As a result, it becomes possible to make a reattempt for recognizing a character once failed to be recognized, with a less burden, compared with that required in the conventional counterpart.

A non-transitory computer-readable storage medium storing a program according to an aspect of the present disclosure includes an instruction to be executed by CPU 11 mounted on a character recognition device for processing an input image and recognizing a character included in the input image. This instruction causes CPU 11 to execute a step of detecting at least one candidate character area having a likelihood higher than zero in the input image, the likelihood being a likelihood of including a character. This instruction causes CPU 11 to execute a step of determining a candidate character area having a likelihood higher than a predetermined threshold as a character area, among the candidate character areas. This instruction causes CPU 11 to execute a step of superimposing the character area over the input image, and of displaying the character area on display 16. The instruction causes CPU 11 to execute a step of acquiring a first user input designating a first point in the input image, via input device 15. This instruction causes CPU 11 to execute a step of raising the likelihood of the candidate character area included in the first correction area near the first point, among the candidate character areas. This instruction causes CPU 11 to execute a step of determining a candidate character area having a likelihood higher than the predetermined threshold as a character area again, among the candidate character areas. This instruction causes CPU 11 to execute a step of superimposing of the character area over the input image and displaying of the resultant image again on display 16. This instruction causes CPU 11 to execute a step of recognizing a character included in the character area.

As a result, it becomes possible to make a reattempt for recognizing a character once failed to be recognized, with a less burden, compared with that required in the conventional counterpart.

### Second Exemplary Embodiment

Described in the first exemplary embodiment is an example in which the character recognition device is configured as an integrated computer including an image capturing device, an input device, and a display; however, the image capturing device, the input device, and the display may be provided separately from the character recognition device.

FIG. 11 is a block diagram illustrating a configuration of character recognition system 40 according to a second exemplary embodiment. Character recognition system 40 in FIG. 11 includes character recognition device 41, image capturing device 42, input device 43, and display 44. Character recognition device 41 is, for example, a desktop computer, and includes bus 10, CPU 11, memory 12, and bus 50, CPU 51, memory 52, and storage 53 configured similarly to storage 13 in FIG. 1. Image capturing device 42, input device 43, and display 44 have the same configurations as those of image capturing device 14, input device 15, and display 16 in FIG. 1, and are connected to bus 50 in character recognition device 41 via input/output interface 54.

Similarly to character recognition device 1 in FIG. 1, character recognition system 40 in FIG. 11 is also capable of correcting the likelihood of the candidate character area, so that the character area once failed to be detected can be detected, and a mistakenly detected character area can be deleted.

### Other Exemplary Embodiments

Some exemplary embodiments have been described as examples of the technique disclosed in the present application. However, the technique in the present disclosure is not limited thereto, and may also be applied to exemplary embodiments in which changes, replacements, additions, omissions, or the like are made as appropriate. Furthermore, the components described in the foregoing exemplary embodiment may be combined to form a new exemplary embodiment.

Accordingly, such other exemplary embodiments will be described below.

Character recognition device 1 in FIG. 1 and character recognition device 41 in FIG. 11 may be connected to another device via a communication circuit, and configured to transmit the recognized character to the other device.

Described in the exemplary embodiments is an example in which the likelihood of the candidate character area is corrected; however, threshold Th may be changed locally near the point designated by the user.

Described in the exemplary embodiments is an example in which a recognition of the character included in the character area is triggered when RECOGNIZE CHARACTER button 33 displayed on display 16 is pressed down; however, a recognition of the characters may also be triggered when a timeout occurs without any correction of the likelihood. It is also possible to keep recognizing the characters in real time, regardless of whether RECOGNIZE CHARACTER button 33 is pressed or not.

Therefore, the components illustrated in the accompanying drawings or described in the detailed description may include not only the elements essential for solving the problems but also components non-essential for solving the problems, for the purpose of illustrating the above technique. Therefore, it should not be immediately recognized that these non-essential elements are essential based on the fact that these non-essential elements are described in the accompanying drawings and the detailed description.

In addition, because the above exemplary embodiments are provided for the purpose of illustrating the technique according to the present disclosure, various modifications, substitutions, additions, omissions, or the like can be made without departing from the scope of the accompanying claims or an equivalent scope thereof.

### INDUSTRIAL APPLICABILITY

A character recognition device, a character recognition method, and a non-transitory computer-readable storage medium storing a program according to one aspect of the present disclosure are applicable to objectives such as, in an attempt for causing a computer to recognize the characters in an image automatically, suppressing character recognition misses, making a reattempt to recognize the character once failed to be recognized, suppressing character recognition mistakes, and/or deleting mistakenly recognized characters.

### REFERENCE MARKS IN THE DRAWINGS

1: character recognition device
10: bus
11: central processing unit (CPU)
12: memory
13: storage
14: image capturing device
15: input device
16: display
20: input image
21a to 21d: cable
31: ADD button
32: DELETE button
33: RECOGNIZE CHARACTER button
34a to 34e: character area
35, 37: point designated by user
36, 38: correction area
40: character recognition system
41: character recognition device
42: image capturing device
43: input device
44: display
50: bus
51: central processing unit (CPU)
52: memory
53: storage
54: input/output interface (I/F)

1. A character recognition device configured to process an input image and to recognize a character included in the input image, the character recognition device comprising:
an arithmetic circuit; and
a memory that stores an instruction executable by the arithmetic circuit,
wherein the arithmetic circuit is configured to, upon executing the instruction:
detect at least one candidate character area having a likelihood higher than zero in the input image, the likelihood being a likelihood of including a character;
determine a candidate character area with a likelihood higher than a predetermined threshold, as a character area, among the at least one candidate character area;
superimpose the character area over the input image, and display a resultant image on a display;
acquire a first user input designating a first point in the input image, via an input device;
raise a likelihood of a candidate character area that is included in a first correction area including the first point, among the at least one candidate character area;
determine a candidate character area having a likelihood higher than the predetermined threshold as a character area again among the at least one candidate character area;
superimpose the character area over the input image and display a resultant image on the display, again; and
recognize a character included in the character area.

2. The character recognition device according to claim 1, wherein the first correction area is an area near the first point.

3. The character recognition device according to claim 1, wherein
the input device includes a pointing device, and
the arithmetic circuit is configured to, upon executing the instruction, increase a size of the first correction area in accordance with a time length accrued in designating the first point with the pointing device, or strength at which the first point is designated by the pointing device.

4. The character recognition device according to claim 1, wherein
the arithmetic circuit is configured to, upon executing the instruction:
acquire a second user input designating a second point in the input image via the input device; and
reduce a likelihood of a candidate character area that is included in a second correction area including the second point, among the at least one candidate character area.

5. The character recognition device according to claim 4, wherein the second correction area is an area near the second point.

6. The character recognition device according to claim 4, wherein the arithmetic circuit is configured, upon executing the instruction, neither to superimpose the candidate character area over the input image nor to display a resultant image on the display, when the likelihood is equal to or less than the predetermined threshold after lowering the likelihood of the candidate character area included in the second correction area.

7. The character recognition device according to claim 4, wherein
the input device includes a pointing device, and
the arithmetic circuit is configured to, upon executing the instruction, increase a size of the second correction area in accordance with a time length accrued in designating the second point with the pointing device, or strength at which the second point is designated by the pointing device.

8. The character recognition device according to claim 1, further comprising an image capturing device that generates the input image.

9. The character recognition device according to claim 1, further comprising the input device and the display.

10. The character recognition device according to claim 9, wherein the input device is a touch panel device integrated with the display.

11. A character recognition method for processing an input image and recognizing a character included in the input image, the character recognition method comprising:
a step of detecting at least one candidate character area having a likelihood higher than zero in the input image, the likelihood being a likelihood of including a character;
a step of determining a candidate character area with a likelihood higher than a predetermined threshold, as a character area, among the at least one candidate character area;
a step of superimposing the character area over the input image, and displaying a resultant image on a display;
a step of acquiring a first user input designating a first point in the input image, via an input device;
a step of raising a likelihood of a candidate character area that is included in a first correction area including the first point, among the at least one candidate character area;
a step of determining a candidate character area having a likelihood higher than the predetermined threshold as the character area again among the at least one candidate character area;
a step of superimposing the character area over the input image and displaying a resultant image again on the display; and
a step of recognizing a character included in the character area.

12. A non-transitory computer-readable storage medium storing a program comprising an instruction executed by an arithmetic circuit implemented in a character recognition device configured to process an input image and to recognize a character included in the input image, the instruction causing the arithmetic circuit to execute:
a step of detecting at least one candidate character area having a likelihood higher than zero in the input image, the likelihood being a likelihood of including a character;
a step of determining a candidate character area with a likelihood higher than a predetermined threshold, as a character area, among the at least one candidate character area;
a step of superimposing the character area over the input image, and displaying a resultant image on a display;
a step of acquiring a first user input designating a first point in the input image, via an input device;
a step of raising a likelihood of a candidate character area that is included in a first correction area including the first point, among the at least one candidate character area;
a step of determining a candidate character area having a likelihood higher than the predetermined threshold as the character area again among the at least one candidate character area;
a step of superimposing the character area over the input image and displaying a resultant image again on the display; and
a step of recognizing a character included in the character area.
